(19) United States
(12) Patent Application Publication
(10) Pub. No.: US 2023/0347736 A1
(43) Pub. Date: Nov. 2, 2023

(54) APPARATUS FOR CONTROLLING TORQUE AND METHOD THEREOF

(71) Applicants: Hyundai Motor Company, Seoul (KR); Kia Corporation, Seoul (KR)

(72) Inventors: Young Sun NAM, Seoul (KR); Chang Hee CHO, Seoul (KR); Chang Hwan KIM, Seoul (KR); In Kyu LEE, Hwaseong-Si (KR); Jae Ho LEE, Seongnam-Si (KR); Doo Hyun KIM, Daegu (KR); Sung Hoon YU, Hwaseong-Si (KR); Lee Hyoung CHO, Suwon-Si (KR); Nam Kwon LEE, Seoul (KR); Young Eun KIM, Uiwang-Si (KR); Jong Wha KIM, Hwaseong-Si (KR); Ye Chan JEONG, Seoul (KR); Beom Jun PARK, Bucheon-Si (KR); Hyun KIM, Hwaseong-Si (KR); Sang Joon KIM, Seoul (KR)

(73) Assignees: Hyundai Motor Company, Seoul (KR); Kia Corporation, Seoul (KR)

(21) Appl. No.: 18/219,039

(22) Filed: Jul. 6, 2023

(30) Foreign Application Priority Data
Feb. 12, 2022 (KR) 10-2022-0166908

(51) Int. Cl. B60K 26/04; B60K 26/02

(52) U.S. Cl. CPC B60K 26/04; B60K 26/02; B60K 2026/046

(57) ABSTRACT

A torque control apparatus may include an input device, a driving device, a memory, and a controller. For example, the torque control apparatus may be configured to obtain an input related to acceleration of the host vehicle from a user by use of the input device, to determine user requirement torque based on the input, to generate a first requirement torque to be input to the driving device for the acceleration of the host vehicle based on at least part of the user requirement torque, to generate an estimation rate value through the first requirement torque by use of a pitch rate estimation model, and to generate a second requirement torque by use of at least one of the estimation rate value, a requirement rate value, the user requirement torque, or a combination of the estimation rate value, the requirement rate value, and the user requirement torque.

### CROSS-REFERENCE TO RELATED APPLICATION

The present application claims priority to Korean Patent Application No. 10-2022-0166908, filed on Dec. 2, 2022, the entire contents of which is incorporated herein for all purposes by this reference.

### BACKGROUND OF THE PRESENT DISCLOSURE

### Field of the Present Disclosure

The present disclosure relates to a torque control apparatus and a method thereof, and more particularly, to a technology for securing a sense of stability in driving by correcting torque for generating acceleration by use of a driving device of a host vehicle based on a pitch rate.

### Description of Related Art

Various driving correction processes are being developed for the driving of a vehicle. For example, a technology for controlling the driving speed or driving direction of a vehicle based on various data is being developed.

Various logic circuits for improving acceleration responsiveness and/or linearity are being studied to improve the feeling of longitudinal acceleration. For example, while the host vehicle is driving, a logic circuit for improving the feeling of longitudinal acceleration may be used by utilizing a longitudinal acceleration perception mechanism by the otolith of a vestibular organ.

Moreover, when a host vehicle is driving on an incline or a speed bump, a user riding the host vehicle feels a pitch based on the driving speed of the host vehicle. To reduce the pitch caused by such a change in driving road, various methods are being developed to correct torque that is configured to control acceleration.

The pitch experienced by the user may be caused by acceleration and deceleration of the host vehicle as well as changes in driving roads. For example, the pitch may occur due to a speed bump and/or a low hill existing on a road on which the host vehicle is driving. For example, the pitch (e.g., a phenomenon in which the nose of a vehicle is raised(up) or lowered(down)) may occur while the host vehicle performs acceleration and/or deceleration while the host vehicle is driving. Accordingly, because a conventional method considers only a longitudinal acceleration, the pitch motion may not be considered, or pitch motion due to acceleration and/or deceleration of the vehicle may not be considered.

Moreover, it is possible to reduce a nose up/down phenomenon of the host vehicle during acceleration and deceleration by “map based” calibration of the requirement torque for acceleration. However, a lot of time and costs may be consumed for data processing.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a torque control apparatus that corrects user requirement torque based on a huma rotation recognition mechanism and then generates the corrected requirement torque, and a method therefor.

Various aspects of the present disclosure are directed to providing a torque control apparatus which is configured for improving riding comfort by reducing the rotational feeling configured for being perceived by a person rather than reducing a pitch value itself, and a method therefor.

Various aspects of the present disclosure are directed to providing a torque control apparatus which is configured for generating the corrected requirement torque by generating an estimation rate value by use of a pitch rate estimation model, and a method therefor.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a torque control apparatus includes at least one input device, a driving device for driving a host vehicle, a memory including one or more instructions, and a controller operatively connected to the input device, the driving device, and the memory. For example, the instructions, when executed by the controller, cause the torque control apparatus to obtain an input related to acceleration of the host vehicle from a user by use of the input device, to determine user requirement torque based on the input, to generate a first requirement torque to be input to the driving device for the acceleration of the host vehicle based on at least part of the user requirement torque, to generate an estimation rate value through the first requirement torque by use of a pitch rate estimation model, and to generate a second requirement torque by use of at least one of the estimation rate value, a requirement rate value, the user requirement torque, or a combination of the estimation rate value, the requirement rate value, and the user requirement torque.

According to an exemplary embodiment of the present disclosure, when executed by the controller, the instructions may cause the torque control apparatus to input the first requirement torque in the pitch rate estimation model and to generate the estimation rate value by use of at least one transfer function included in the pitch rate estimation model.

According to an exemplary embodiment of the present disclosure, the at least one transfer function may include a second-order system related to the acceleration of the host vehicle.

According to an exemplary embodiment of the present disclosure, when executed by the controller, the instructions may cause the torque control apparatus to generate corrected requirement torque by subtracting the estimation rate value generated from the pitch rate estimation model from the requirement rate value, multiplying a result of the subtracting by a predetermined gain, and adding a result of the multiplying to the user requirement torque.

According to an exemplary embodiment of the present disclosure, when executed by the controller, the instructions may cause the torque control apparatus to generate the second requirement torque by applying at least one of a perceptual-based filter, a gradient limiting function, or a combination of the perceptual-based filter and the gradient limiting function to the corrected requirement torque.

According to an exemplary embodiment of the present disclosure, the requirement rate value may substantially correspond to 0.

According to an exemplary embodiment of the present disclosure, the at least one input device may include at least one of an accelerator pedal, a cruise control device, or a combination of the accelerator pedal and the cruise control device. The input related to the acceleration of the host vehicle may include at least one of a pressure input of the user to the accelerator pedal included in the input unit, an acceleration input of the host vehicle by use of the cruise control device, or a combination of the pressure input of the user and the acceleration input of the host vehicle.

According to an exemplary embodiment of the present disclosure, the torque control apparatus may further include a sensor device operatively connected to the controller. For example, when executed by the controller, the instructions may cause the torque control apparatus to generate the estimation rate value by use of at least one of a longitudinal acceleration of the host vehicle, a driving speed of the host vehicle, or a combination of the longitudinal acceleration and the driving speed, which is obtained by use of the sensor device.

According to an aspect of the present disclosure, a torque control method includes obtaining, by a controller, an input related to acceleration of a host vehicle from a user by use of an input device, determining, by the controller, a user requirement torque based on the input, generating, by the controller, a first requirement torque to be input to a driving device for the acceleration of the host vehicle based on at least part of the user requirement torque, generating, by the controller, an estimation rate value through the first requirement torque by use of a pitch rate estimation model, and generating, by the controller, a second requirement torque by use of at least one of the estimation rate value, a requirement rate value, the user requirement torque, or a combination of the estimation rate value, the requirement rate value, and the user requirement torque.

According to an exemplary embodiment of the present disclosure, the generating, by the controller, of the estimation rate value may include inputting, by the controller, the first requirement torque in the pitch rate estimation model, and generating, by the controller, the estimation rate value by use of at least one transfer function included in the pitch rate estimation model.

According to an exemplary embodiment of the present disclosure, the at least one transfer function may include a second-order system related to the acceleration of the host vehicle.

According to an exemplary embodiment of the present disclosure, the generating, by the controller, of the estimation rate value may include generating, by the controller, corrected requirement torque by subtracting the estimation rate value generated from the pitch rate estimation model from the requirement rate value, multiplying a result of the subtracting by a predetermined gain, and adding a result of the multiplying to the user requirement torque.

According to an exemplary embodiment of the present disclosure, the generating, by the controller, of the second requirement torque may include generating, by the controller, the second requirement torque by applying at least one of a perceptual-based filter, a gradient limiting function, or a combination of the perceptual-based filter and the gradient limiting function to the corrected requirement torque.

According to an exemplary embodiment of the present disclosure, the requirement rate value may substantially correspond to 0.

According to an exemplary embodiment of the present disclosure, the input related to the acceleration of the host vehicle may include at least one of a pressure input of the user to an accelerator pedal included in the input unit, an acceleration input of the host vehicle by use of a cruise control device, or a combination of the pressure input of the user and the acceleration input of the host vehicle.

According to an aspect of the present disclosure, a computer-readable recording medium including a program for executing a torque control method includes obtaining, by a controller, an input related to acceleration of a host vehicle from a user by use of an input device, determining, by the controller, a user requirement torque based on the input, generating, by the controller, a first requirement torque to be input to a driving device for the acceleration of the host vehicle based on at least part of the user requirement torque, generating, by the controller, an estimation rate value through the first requirement torque by use of a pitch rate estimation model, and generating, by the controller, a second requirement torque by use of at least one of the estimation rate value, a requirement rate value, the user requirement torque, or a combination of the estimation rate value, the requirement rate value, and the user requirement torque.

According to an exemplary embodiment of the present disclosure, the generating, by the controller, of the estimation rate value may include inputting, by the controller, the first requirement torque in the pitch rate estimation model, and generating, by the controller, the estimation rate value by use of at least one transfer function included in the pitch rate estimation model.

According to an exemplary embodiment of the present disclosure, the at least one transfer function may include a second-order system related to the acceleration of the host vehicle.

According to an exemplary embodiment of the present disclosure, the generating, by the controller, of the estimation rate value may include generating, by the controller, corrected requirement torque by subtracting the estimation rate value generated from the pitch rate estimation model from the requirement rate value, multiplying a result of the subtracting by a predetermined gain, and adding a result of the multiplying to the user requirement torque.

According to an exemplary embodiment of the present disclosure, the generating, by the controller, of the second requirement torque may include generating, by the controller, the second requirement torque by applying at least one of a perceptual-based filter, a gradient limiting function, or a combination of the perceptual-based filter and the gradient limiting function to the corrected requirement torque.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing components of a torque control apparatus, according to an exemplary embodiment of the present disclosure;

FIG. 2 is a circuit diagram showing an operation of a torque control apparatus, according to an exemplary embodiment of the present disclosure;

FIG. 3 is an operational conceptual diagram illustrating an operation of a torque control apparatus, according to an exemplary embodiment of the present disclosure;

FIG. 4 is an operation flowchart of a torque control apparatus, according to an exemplary embodiment of the present disclosure;

FIG. 5 is an operation flowchart of a torque control apparatus, according to an exemplary embodiment of the present disclosure; and

FIG. 6 illustrates a computing system related to a torque control method, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to components of each drawing, it should be noted that the same components have the same reference numerals, although they are indicated on another drawing. Furthermore, in describing the exemplary embodiments of the present disclosure, detailed descriptions associated with well-known functions or configurations will be omitted when they may make subject matters of the present disclosure unnecessarily obscure.

In describing elements of embodiments of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning which is consistent with their meaning in the context of the present disclosure and the relevant art and will not be interpreted in an idealized or overly formal sense unless expressly so defined herein.

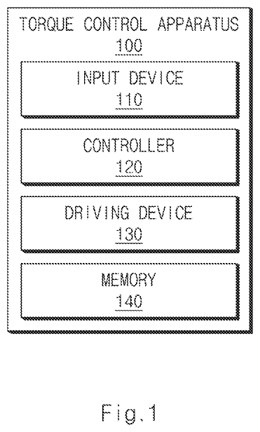

Hereinafter, various embodiments of the present disclosure will be described in detail with reference to FIGS. 1 to 6.

FIG. 1 is a block diagram showing components of a torque control apparatus, according to an exemplary embodiment of the present disclosure.

According to an exemplary embodiment of the present disclosure, a torque control apparatus 100 may include at least one of an input device 110, a controller 120, a driving device 130, a memory 140, or any combination thereof.

According to an exemplary embodiment of the present disclosure, the input device 110 may include at least one input device.

For example, the input device 110 may include at least one of an accelerator pedal, an external controller (e.g., a cruise control device), or any combination thereof. For example, the input device 110 may receive a user's pressure input to the accelerator pedal. For example, the input device 110 may receive an input related to acceleration of a host vehicle delivered from an external controller and may deliver the received input to the controller 120.

According to an exemplary embodiment of the present disclosure, the controller 120 may be operatively connected to the input device 110, the driving device 130, and/or the memory 140. The controller 120 may be configured for controlling operations of the input device 110, the driving device 130, and/or the memory 140. For example, the controller 120 may include a powertrain controller.

For example, the controller 120 may be configured to generate requirement torque for generating acceleration of the host vehicle through the driving device 130.

For example, the controller 120 may receive an input related to acceleration of the host vehicle from the input device 110 and then may be configured to determine user requirement torque based on the received input. For example, the user requirement torque may be determined based on at least one of input strength, strength, information, or any combination thereof.

For example, the controller 120 may be configured to generate a first requirement torque input to the driving device 130 to accelerate the host vehicle based on at least part of the user requirement torque. For example, the first requirement torque may be a torque value generated by applying at least one filter (e.g., at least one of a perceptual-based filter, a gradient limiting function, or any combination thereof) to the user requirement torque.

For example, the first requirement torque may be a requirement torque value finally delivered to the driving device 130 before an algorithm according to various exemplary embodiments of the present disclosure is applied thereto. For example, the first requirement torque may be a final requirement torque value performed immediately before according to an algorithm of the present disclosure.

For example, the controller 120 may be configured to generate an estimation rate value through the first requirement torque by use of a pitch rate estimation model.

For example, the controller 120 may input the first requirement torque to the pitch rate estimation model and may be configured to generate an estimation rate value by use of at least one transfer function included in the pitch rate estimation model. For example, the at least one transfer function may include a second-order system related to the acceleration of the host vehicle.

For example, the controller 120 may be configured to generate an estimation rate value through information obtained by use of another component (e.g., a sensor device) not shown in FIG. 1. For example, the controller 120 may be configured to generate an estimation rate value or correct the generated estimation rate value by use of at least one of the longitudinal acceleration, driving speed, or any combination of the host vehicle, which is obtained by use of a sensor device.

For example, the controller 120 may subtract the estimation rate value generated from the pitch rate estimation model from the requirement rate value, may multiply the subtracted result by the specified gain, and may add the multiplied result to the user requirement torque to generate the corrected requirement torque.

For example, the requirement rate value may substantially correspond to 0.

For example, the controller 120 may be configured to generate a second requirement torque by applying at least one filter (e.g., at least one of a perceptual-based filter, a gradient limiting function, or any combination thereof) to the corrected requirement torque.

For example, after generating the second requirement torque, the controller 120 may be configured to generate new requirement torque (e.g., third requirement torque) by repeatedly performing substantially the same operation as the above-described operations.

According to an exemplary embodiment of the present disclosure, the driving device 130 may include at least one of a motor, an engine, or any combination thereof.

For example, the driving device 130 may accelerate the host vehicle based on torque (e.g., second requirement torque) delivered from the controller 120.

According to an exemplary embodiment of the present disclosure, the memory 140 may store instructions or data. For example, the memory 140 may store one or more instructions that cause the torque control apparatus 100 to perform various operations when executed by the controller 120.

For example, the memory 140 and the controller 120 may be implemented as one chipset. The controller 120 may include at least one of a communication processor or a modem.

For example, the memory 140 may store various pieces of information related to the torque control apparatus 100. For example, the memory 140 may store information related to the operation history of the controller 120. For example, the memory 140 may store information related to states and/or operations of components (e.g., at least one of an engine control unit (ECU), the input device 110, the controller 120, the driving device 130, or any combination thereof) of the host vehicle.

The configuration of the torque control apparatus 100 shown in FIG. 1 is an example, and embodiments of the present disclosure are not limited thereto. In an exemplary embodiment of the present disclosure, the torque control apparatus 100 may further include a sensor device.

For example, the torque control apparatus 100 may obtain driving information (e.g., at least one of longitudinal acceleration, driving speed, or any combination thereof) of the host vehicle by use of a sensor device and then may be configured to generate an estimation rate value by use of the obtained information or correct the generated estimation rate value.

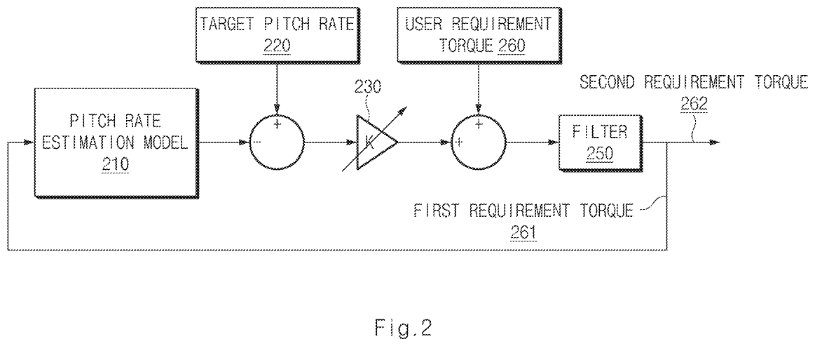

FIG. 2 is a circuit diagram showing an operation of a torque control apparatus, according to an exemplary embodiment of the present disclosure.

According to an exemplary embodiment of the present disclosure, a torque control apparatus (e.g., the torque control apparatus 100 of FIG. 1) may be configured to generate a second requirement torque 262 by use of a pitch rate estimation model 210 and a filter 250.

According to an exemplary embodiment of the present disclosure, the torque control apparatus may be configured to determine user requirement torque 260 based on the input received through an input device (e.g., the input device 110 in FIG. 1) from a first user.

According to an exemplary embodiment of the present disclosure, the torque control apparatus may be configured to generate a first requirement torque 261 input to a driving device (e.g., the driving device 130 of FIG. 1) to accelerate the host vehicle based on at least part of user requirement torque 260.

For example, the torque control apparatus may be configured to generate the first requirement torque 261 by applying at least one filter 250 (e.g., at least one of a perceptual-based filter, a gradient limiting function, or any combination thereof) to the user requirement torque 260.

According to an exemplary embodiment of the present disclosure, the torque control apparatus may be configured to generate an estimation rate value by use of the pitch rate estimation model 210.

For example, the torque control apparatus may input the first requirement torque 261 to the pitch rate estimation model 210 and then may be configured to generate an estimation rate value by use of at least one transfer function included in the pitch rate estimation model.

According to an exemplary embodiment of the present disclosure, the torque control apparatus may subtract an estimation rate value output from the pitch rate estimation model 210 from a target pitch rate 220 (or a requirement rate value).

For example, the target pitch rate 220 may substantially correspond to zero.

According to an exemplary embodiment of the present disclosure, the torque control apparatus may subtract an estimation rate value generated from the pitch rate estimation model 210 from the target pitch rate 220, may multiply the subtracted result by a specified gain, and may add the multiplied result with the user requirement torque 260 to generate the corrected requirement torque.

According to an exemplary embodiment of the present disclosure, the torque control apparatus may be configured to generate a second requirement torque 262 by applying at least one filter 250 (e.g., at least one of a perceptual-based filter, a gradient limiting function, or any combination thereof) to the corrected requirement torque.

According to an exemplary embodiment of the present disclosure, the torque control apparatus may again input the second requirement torque 262 to the pitch rate estimation model 210 and then may be configured to generate new requirement torque (e.g., third requirement torque) by repeating the above-described operation.

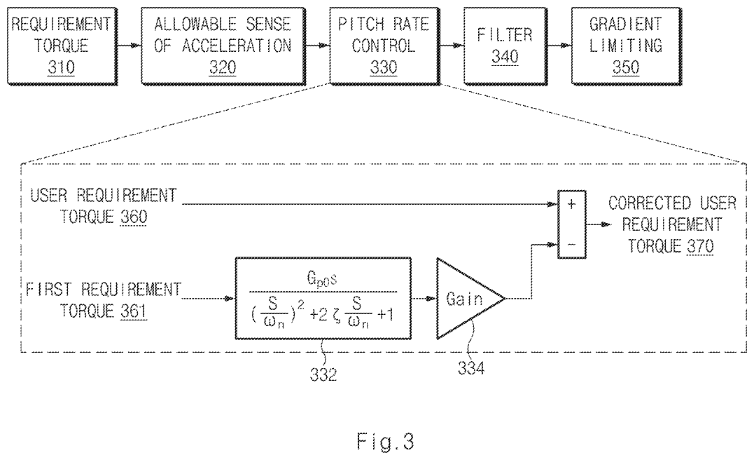

FIG. 3 is an operational conceptual diagram illustrating an operation of a torque control apparatus, according to an exemplary embodiment of the present disclosure.

According to an exemplary embodiment of the present disclosure, a torque control apparatus (e.g., the torque control apparatus 100 in FIG. 1) may be configured to generate new requirement torque by applying control mechanisms corresponding to reference numerals 310 to 350.

Referring to reference number 310, according to an exemplary embodiment of the present disclosure, the torque control apparatus may be configured to determine requirement torque. For example, the torque control apparatus may be configured to determine user requirement torque 360 based on the input received from a user.

Referring to reference number 320, according to an exemplary embodiment of the present disclosure, the torque control apparatus may correct user requirement torque based on an allowable sense of acceleration. For example, the torque control apparatus may correct the determined user requirement torque based on a predetermined allowable sense of acceleration. For example, first requirement torque 361 may be generated by correcting user requirement torque by applying an algorithm based on the perception of acceleration. As an exemplary embodiment of the present disclosure, the first requirement torque 361 may be generated by applying at least one filter to the user requirement torque.

Referring to reference number 330, according to an exemplary embodiment of the present disclosure, the torque control apparatus may be configured to generate corrected user requirement torque 370 through pitch rate control.

For example, the torque control apparatus may input the first requirement torque 361 to at least one transfer function 332 included in a pitch rate estimation model (e.g., the pitch rate estimation model 210 in FIG. 2) and then may subtract a value obtained by multiplying a specified gain 334 from the user requirement torque 360.

For example, although not illustrated in drawings, the torque control apparatus may subtract the result (e.g., an estimation rate value), which is determined by inputting the first requirement torque 361 to the at least one transfer function 332, from a target pitch rate (e.g., the target pitch rate 220 in FIG. 2) and then may subtract a value, which is obtained by multiplying the specified gain 334, from the user requirement torque 360.

For example, the above result value may be negative.

For example, the torque control apparatus may identify a value, which is obtained by subtracting the above-described result value from the user requirement torque 360, as corrected user requirement torque 370.

Referring to reference number 340, according to an exemplary embodiment of the present disclosure, the torque control apparatus may apply at least one filter to the corrected user requirement torque 370. The at least one filter may include a perception-based filter, but embodiments of the present disclosure are not limited thereto.

Referring to reference number 350, according to an exemplary embodiment of the present disclosure, a torque control apparatus may apply a gradient limiting function to a torque value to which at least one filter is applied.

According to an exemplary embodiment of the present disclosure, the torque control apparatus may be configured to generate a second requirement torque by performing operations of reference numerals 310 to 350.

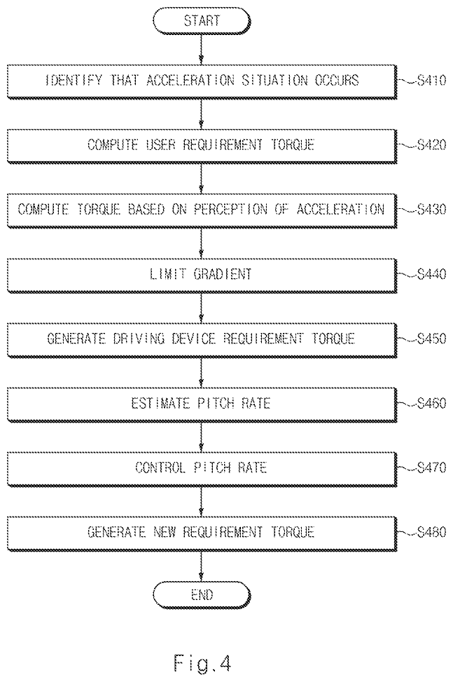

FIG. 4 is an operation flowchart of a torque control apparatus, according to an exemplary embodiment of the present disclosure.

According to an exemplary embodiment of the present disclosure, a torque control apparatus (e.g., the torque control apparatus 100 of FIG. 1) may perform operations described in FIG. 4. For example, at least some of components (e.g., the input device 110, the controller 120, the driving device 130, and/or the memory 140 of FIG. 1) included in the torque control apparatus may be configured to perform the operations of FIG. 4.

In the following embodiment, S410 to S480 may be sequentially performed, but are not always performed sequentially. For example, the order of operations may be changed, and at least two operations may be performed in parallel. Moreover, descriptions corresponding to or identical to the above-mentioned descriptions provided with reference to FIG. 4 may be briefly described or omitted to avoid redundancy.

According to an exemplary embodiment of the present disclosure, the torque control apparatus may identify that an acceleration situation occurs (S410).

For example, the torque control apparatus may identify that the acceleration situation occurs, based on receiving a user input (e.g., at least one of pressure on an accelerator pedal, an acceleration input to a cruise control device, or any combination thereof) to an input device.

According to an exemplary embodiment of the present disclosure, the torque control apparatus may compute (or determine) user requirement torque (S420).

For example, the torque control apparatus may be configured to determine the user requirement torque based on the received input.

According to an exemplary embodiment of the present disclosure, the torque control apparatus may perform a torque determination operation based on the perception of acceleration (S430).

For example, the torque control apparatus may be configured to generate a torque value corrected by performing a torque determination operation based on the perception of acceleration on the user requirement torque.

For example, the torque determination operation based on the perception of acceleration may include the operation of a perception-based filter.

According to an exemplary embodiment of the present disclosure, the torque control apparatus may apply a gradient limiting function (S440).

For example, the torque control apparatus may apply the gradient limiting function to the corrected torque value. For example, the torque control apparatus may apply at least one filter (e.g., at least one of a perceptual-based filter, a gradient limiting function, or any combination thereof).

According to an exemplary embodiment of the present disclosure, the torque control apparatus may be configured to generate driving device requirement torque (S450).

For example, the torque control apparatus may be configured to generate a first requirement torque for generating acceleration through an input to a driving device (e.g., the driving device 130 of FIG. 1).

According to an exemplary embodiment of the present disclosure, the torque control apparatus may estimate a pitch rate (S460).

For example, the torque control apparatus may input first requirement torque into a pitch rate estimation model (e.g., the pitch rate estimation model 210 of FIG. 2) and then may be configured to generate an estimation rate value by use of at least one transfer function included in the pitch rate estimation model.

According to an exemplary embodiment of the present disclosure, the torque control apparatus may perform a pitch rate control operation (r).

For example, the torque control apparatus may subtract the estimation rate value from the requirement rate value. For example, the requirement rate value may substantially correspond to 0.

For example, the torque control apparatus may be configured to generate the corrected user requirement torque (e.g., the corrected user requirement torque 370 in FIG. 3) by subtracting the estimation rate value from the requirement rate value, multiplying the subtracted result by a specified gain, and adding the multiplied result to the user requirement torque.

According to an exemplary embodiment of the present disclosure, the torque control apparatus may be configured to generate new requirement torque (S480).

For example, to generate the new requirement torque (or second requirement torque), the torque control apparatus may apply at least one filter (e.g., at least one of a perceptual-based filter, a gradient limiting function, or any combination thereof) to the corrected user requirement torque.

According to an exemplary embodiment of the present disclosure, after performing S480, the torque control apparatus may be configured to generate the new requirement torque by repeatedly performing S430 to S440 again by use of the second requirement torque and the user requirement torque based on the newly received input.

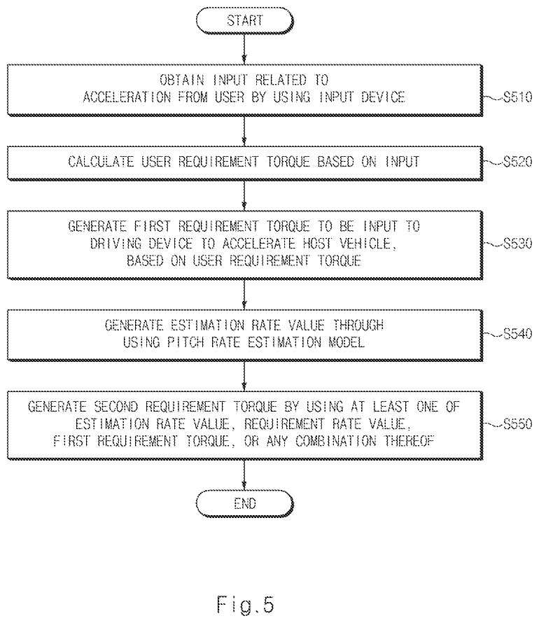

FIG. 5 is an operation flowchart of a torque control apparatus, according to an exemplary embodiment of the present disclosure.

According to an exemplary embodiment of the present disclosure, a torque control apparatus (e.g., the torque control apparatus 100 of FIG. 1) may perform operations described in FIG. 5. For example, at least some of components (e.g., the input device 110, the controller 120, the driving device 130, and/or the memory 140 of FIG. 1) included in the torque control apparatus may be configured to perform the operations of FIG. 5.

In the following embodiment, S510 to S550 may be sequentially performed, but are not always performed sequentially. For example, the order of operations may be changed, and at least two operations may be performed in parallel. Moreover, descriptions corresponding to or identical to the above-mentioned descriptions provided with reference to FIG. 5 may be briefly described or omitted to avoid redundancy.

According to an exemplary embodiment of the present disclosure, the torque control apparatus may obtain an input related to acceleration from a user by use of an input device (S510).

For example, the at least one input device may include at least one of an accelerator pedal, a cruise control device, or any combination thereof. The torque control apparatus may obtain an input related to acceleration of a host vehicle including at least one of a user's pressure input for the accelerator pedal included in the input device, an acceleration input of a host vehicle by use of a cruise control device, or any combination thereof.

According to an exemplary embodiment of the present disclosure, the torque control apparatus may be configured to determine user requirement torque based on the input (S520).

For example, the torque control apparatus may be configured to determine the user requirement torque based on the received input.

According to an exemplary embodiment of the present disclosure, based on the user requirement torque, the torque control apparatus may be configured to generate a first requirement torque to be input to a driving device to accelerate a host vehicle (S530).

For example, the torque control apparatus may be configured to generate a first requirement torque by applying at least one filter (e.g., at least one of a perceptual-based filter, a gradient limiting function, an allowable sense of acceleration, or any combination thereof) to the user requirement torque.

According to an exemplary embodiment of the present disclosure, the torque control apparatus may be configured to generate an estimation rate value through the first requirement torque by use of a pitch rate estimation model (S540).

For example, the torque control apparatus may input first requirement torque into a pitch rate estimation model (e.g., the pitch rate estimation model 210 of FIG. 2) and then may be configured to generate an estimation rate value by use of at least one transfer function included in the pitch rate estimation model.

According to an exemplary embodiment of the present disclosure, the torque control apparatus may be configured to generate a second requirement torque by use of at least one of an estimation rate value, a requirement rate value, the first requirement torque, or any combination thereof (S550).

For example, the torque control apparatus may subtract the estimation rate value from the requirement rate value. For example, the requirement rate value may substantially correspond to 0.

For example, the torque control apparatus may be configured to generate the corrected user requirement torque (e.g., the corrected user requirement torque 370 in FIG. 3) by subtracting the estimation rate value from the requirement rate value, multiplying the subtracted result by a specified gain, and adding the multiplied result to the user requirement torque.

For example, to generate second requirement torque, the torque control apparatus may apply at least one filter (e.g., at least one of a perceptual-based filter, a gradient limiting function, or any combination thereof) to the corrected user requirement torque.

According to an exemplary embodiment of the present disclosure, after performing S550, the torque control apparatus may be configured to generate the new requirement torque by repeatedly performing S520 to S550 again by use of the second requirement torque and the user requirement torque based on the newly received input.

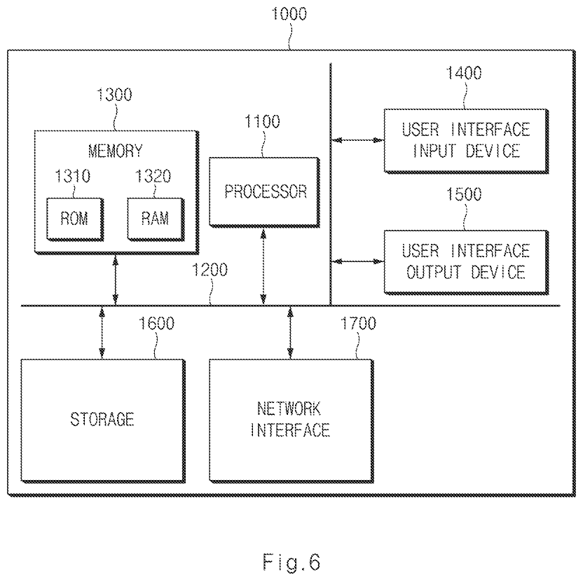

FIG. 6 illustrates a computing system related to a torque control method, according to an exemplary embodiment of the present disclosure.

Referring to FIG. 6, a computing system 1000 related to a torque control method may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the exemplary embodiments included in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, various embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of a torque control apparatus according to an exemplary embodiment of the present disclosure, and a method therefor are as follows.

According to at least one of embodiments of the present disclosure, while a host vehicle is accelerating, a smooth and stable ride may be provided by reducing a pitch sense (e.g., an extent to which the host vehicle is lifted).

Moreover, according to at least one of embodiments of the present disclosure, human cognition may be effectively improved by controlling a pitch rate (or angular velocity), which affects the human perception of rotation, rather than controlling a pitch itself, and it may be advantageous in terms of improving marketability.

Furthermore, according to at least one of embodiments of the present disclosure, data throughput or man-hour cost for control may be reduced compared to conventional control logic for improving riding comfort.

Besides, according to at least one of embodiments of the present disclosure, because no additional components (e.g., sensors) are required, manufacturing costs may be reduced. Delay factors may be reduced by implementing control logic through feed-forward control.

Besides, a variety of effects directly or indirectly understood through the specification may be provided.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

A singular expression includes a plural expression unless the context clearly indicates otherwise.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A torque control apparatus comprising:
at least one input device;
a driving device for driving a host vehicle;
a memory including one or more instructions; and
a controller operatively connected to the at least one input device, the driving device, and the memory,
wherein the instructions, when executed by the controller, cause the torque control apparatus to:
obtain an input related to acceleration of the host vehicle from a user by use of the at least one input device;
determine user requirement torque based on the input;
generate a first requirement torque to be input to the driving device for the acceleration of the host vehicle based on at least part of the user requirement torque;
generate an estimation rate value through the first requirement torque by use of a pitch rate estimation model; and
generate a second requirement torque by use of at least one of the estimation rate value, a requirement rate value, the user requirement torque, or a combination of the estimation rate value, the requirement rate value, and the user requirement torque.

2. The torque control apparatus of claim 1, wherein the instructions, when executed by the controller, cause the torque control apparatus to:
input the first requirement torque in the pitch rate estimation model; and
generate the estimation rate value by use of at least one transfer function included in the pitch rate estimation model.

3. The torque control apparatus of claim 2, wherein the at least one transfer function includes a second-order system related to the acceleration of the host vehicle.

4. The torque control apparatus of claim 1, wherein the instructions, when executed by the controller, cause the torque control apparatus to generate corrected requirement torque by subtracting the estimation rate value generated from the pitch rate estimation model from the requirement rate value, multiplying a result of the subtracting by a predetermined gain, and adding a result of the multiplying to the user requirement torque.

5. The torque control apparatus of claim 4, wherein the instructions, when executed by the controller, cause the torque control apparatus to generate the second requirement torque by applying at least one of a perceptual-based filter, a gradient limiting function, or a combination of the perceptual-based filter and the gradient limiting function to the corrected requirement torque.

6. The torque control apparatus of claim 1, wherein the requirement rate value substantially corresponds to 0.

7. The torque control apparatus of claim 1,
wherein the at least one input device includes at least one of an accelerator pedal, a cruise control device, or a combination of the accelerator pedal and the cruise control device, and
wherein the input related to the acceleration of the host vehicle includes at least one of a pressure input of the user to the accelerator pedal included in the at least one input device, an acceleration input of the host vehicle by use of the cruise control device, or a combination of the pressure input of the user and the acceleration input of the host vehicle.

8. The torque control apparatus of claim 1, further including:
a sensor device operatively connected to the controller,
wherein the instructions, when executed by the controller, cause the torque control apparatus to generate the estimation rate value by use of at least one of a longitudinal acceleration of the host vehicle, a driving speed of the host vehicle, or a combination of the longitudinal acceleration and the driving speed, which is obtained by use of the sensor device.

9. A torque control method, the method comprising:
obtaining, by a controller, an input related to acceleration of a host vehicle from a user by use of an input device;
determining, by the controller, a user requirement torque based on the input;
generating, by the controller, a first requirement torque to be input to a driving device for the acceleration of the host vehicle based on at least part of the user requirement torque;
generating, by the controller, an estimation rate value through the first requirement torque by use of a pitch rate estimation model; and
generating, by the controller, a second requirement torque by use of at least one of the estimation rate value, a requirement rate value, the user requirement torque, or a combination of the estimation rate value, the requirement rate value, and the user requirement torque.

10. The method of claim 9, wherein the generating, by the controller, of the estimation rate value includes:
inputting, by the controller, the first requirement torque in the pitch rate estimation model; and
generating, by the controller, the estimation rate value by use of at least one transfer function included in the pitch rate estimation model.

11. The method of claim 10, wherein the at least one transfer function includes a quadratic function related to the acceleration of the host vehicle.

12. The method of claim 9, wherein the generating, by the controller, of the estimation rate value includes:
generating, by the controller, corrected requirement torque by subtracting the estimation rate value generated from the pitch rate estimation model from the requirement rate value, multiplying a result of the subtracting by a predetermined gain, and adding a result of the multiplying to the user requirement torque.

13. The method of claim 12, wherein the generating, by the controller, of the second requirement torque includes:
generating, by the controller, the second requirement torque by applying at least one of a perceptual-based filter, a gradient limiting function, or a combination of the perceptual-based filter and the gradient limiting function to the corrected requirement torque.

14. The method of claim 9, wherein the requirement rate value substantially corresponds to 0.

15. The method of claim 9, wherein the input related to the acceleration of the host vehicle includes:
at least one of a pressure input of the user to an accelerator pedal included in the input unit, an acceleration input of the host vehicle by use of a cruise control device, or a combination of the pressure input of the user and the acceleration input of the host vehicle.

16. A computer-readable recording medium including a program for executing a torque control method, the torque control method comprising:
obtaining, by a controller, an input related to acceleration of a host vehicle from a user by use of an input device;
determining, by the controller, a user requirement torque based on the input;
generating, by the controller, a first requirement torque to be input to a driving device for the acceleration of the host vehicle based on at least part of the user requirement torque;
generating, by the controller, an estimation rate value through the first requirement torque by use of a pitch rate estimation model; and
generating, by the controller, a second requirement torque by use of at least one of the estimation rate value, a requirement rate value, the user requirement torque, or a combination of the estimation rate value, the requirement rate value, and the user requirement torque.

17. The computer-readable recording medium of claim 16, wherein the generating, by the controller, of the estimation rate value includes:
inputting, by the controller, the first requirement torque in the pitch rate estimation model; and
generating, by the controller, the estimation rate value by use of at least one transfer function included in the pitch rate estimation model.

18. The computer-readable recording medium of claim 17, wherein the at least one transfer function includes a second-order system related to the acceleration of the host vehicle.

19. The computer-readable recording medium of claim 16, wherein the generating, by the controller, of the estimation rate value includes:
generating, by the controller, corrected requirement torque by subtracting the estimation rate value generated from the pitch rate estimation model from the requirement rate value, multiplying a result of the subtracting by a predetermined gain, and adding a result of the multiplying to the user requirement torque.

20. The computer-readable recording medium of claim 19, wherein the generating, by the controller, of the second requirement torque includes:
generating, by the controller, the second requirement torque by applying at least one of a perceptual-based filter, a gradient limiting function, or a combination of the perceptual-based filter and the gradient limiting function to the corrected requirement torque.
